(19) United States
(12) Patent Application Publication
(10) Pub. No.: US 2005/0210938 A1
(43) Pub. Date: Sep. 29, 2005

(54) Developments for magnetic latches

(76) Inventors: David Doyle, Cremorne (AU); Neil Dunne, Cammeray (AU); David Calabria, Manly (AU); Anthony John Clark, Cremorne (AU)

Correspondence Address: GARY M. ANDERSON,ESQ.;FULWIDER,PATTON,LEE & UTECHT,LLP, 200 OCEANGATE, SUITE 1550, LONG BEACH, CA, 90802, US

(21) Appl. No.: 10/848,040

(22) Filed: May 17, 2004

(30) Foreign Application Priority Data
Mar. 24, 2004 (AU) 2004901573

(51) Int. Cl. E05B 47/00

(52) U.S. Cl. 70/276

(57) ABSTRACT

A self-latching device is disclosed which is arranged to latch, in a predetermined position, two members which are otherwise movable relative to each other such as a hinged gate. The device comprises a latch arm having a latch element and a manual actuator mounted on one of the members and which is movable between a latched and a retracted position, by upward manual displacement of the actuator, and a retaining element incorporating a permanent magnet mounted on the other member. The latch arm is spring biased into the retracted position but, when in the predetermined position, is caused to move by the magnetic field generated by the magnetic into the latched position wherein any substantial relative movement of the two members is prevented by the latch arm engaging the retaining element. A lost motion connection is provided between the actuator and the latch element either by being in the form of a flexible line or through a multiple element linkage such that upon latching, the actuator falls to a rest position without applying any substantial load on the latch element.

### FIELD OF THE INVENTION

The present invention relates to magnetic latches suitable for use on gates such as swimming pool gates and other similar installations where automatic latching is required when the moveable structure is displaced to a position at which it is to be latched. An actuator is provided for unlatching so that the gate or other structure can be moved, usually pivotally, away from its latching position.

### BACKGROUND OF THE INVENTION

The present invention in various embodiments offers new and useful alternatives to previously available options and indeed lends itself to embodiments which may incorporate security locks such as quality cylinder locks.

A significant development in magnetic latching and devices is the subject of the PCT International Publication WO92/03631 on the basis of which U.S. Pat. No. 5,362,116 was issued to David Doyle and Neil Dunne. This invention has been assigned to the assignees of the present invention. The Doyle and Dunne invention relates to a vertically operating magnetic latch particularly for a swimming pool gate with a lost motion arrangement so that the latching pin, after manual retraction and after opening the gate, is retained in an elevated retracted position by spring biasing and the actuating mechanism does not apply downward load imposing forces against the biasing spring. While this device has been successfully exploited, the present invention has been conceived to offer novel inventive and alternative embodiments for different applications in a different form. Indeed the present invention may be applied to provide magnetic latching as an alternative to conventional striker plates with spring door latches and the invention may lend itself to versions incorporating locks.

Embodiments of the invention are envisaged as extending both to manually actuatable versions (such as by the use of rotary knobs or rotatable handles) but also extends to actuation by other means such as solenoids or electric motors which lends itself to actuation from a remote location. Of particular advantage and significance in these embodiments is the inherent characteristics of magnetic latching as demonstrated by the Doyle and Dunne prior patent whereby when eg a door is swung to its closed position, there is no force required to displace a spring biased latch pin prior to it entering into latching engagement. This is especially valuable in installations having an automatic door closing device.

### SUMMARY OF THE INVENTION

According to the present invention there is provided a self-latching device for latching, in a predetermined position, two members which are otherwise moveable relative to one another, the device comprising:
(i) a latch arm; and
(ii) a retaining element which in use provides a latching shoulder for the latch arm to prevent relative movement of the members;
(iii) at least one of the latch arm and the retaining element providing a strong magnetic field and the other having magnetic properties; and
the latch arm being arranged to be displaceably mounted on a first of said members and the retaining element being arranged to be associated with the second of said members.

When the members are in the predetermined position, under the influence of the magnetic field the latch arm and retaining element undergo relative movement into a latching position whereby relative movement of the two members is substantially prevented by an engagement portion of the latch arm and latching shoulder of the retaining element; interengaging the latch arm being displaceable under applied force away from the retaining element to a retracted position so that the members may be moved apart.

The device further comprises:
(i) a biasing means arranged to bias the latch arm into the retracted position, and impart a force on the latch arm which is less than the biasing force imparted on the latch arm by the magnetic field when the members are located in the predetermined position;
(ii) actuating means are arranged to be mounted on the first of the members in association with the latch arm to respond to an actuating input to displace the latch arm from its latching position to its retracted position, whereby the two members may be moved apart away from the predetermined position and, on removal of the actuation input, restoring means returns the actuating means to its initial position and the biasing means maintains the latch arm substantially in its retracted position, the latch arm then being displaceable under the magnetic forces to its in the predetermined position against the biasing means to re-establish its latching position; and
(iii) the actuating means substantially avoids load being applied to the latch arm in all its positions by either:
   (a) a multi-link structure having a degree of lost motion at each link, or
   (b) a flexible structure which buckles when the latch is not engaged and the actuating means released but extends to absorb slack when the latch arm is in the latching position, whereby little or no displacement by the actuating means is required to commence displacement of the latch arm.

A particular significant and useful embodiment is one wherein the latch arm is mounted for reciprocation in a housing and the housing also mounts the actuator which may be in the form of a pull knob attached to a flexible line or multi-link connector or a rotatable handle could be provided. The knobs or handle might incorporate a cylinder lock for security reasons.

Embodiments may have the high strength magnet material sealed within the body of the retaining element and the latch arm then has a steel pin providing the latching portion and of a suitable grade of steel having magnetic properties.

In place of a knob or handle for the actuating means, the invention lends itself to embodiments which are remotely actuated, for example electrically by the use of a solenoid arrangement or motor to cause motion of the actuator for retraction of the latching arm.

Generally arrangements embodying the present invention incorporate a lost motion interconnection between the actuator and the latch arm arm such that little or preferably no load is applied to the latching arm and its biasing means when in the retracted position.

In one embodiment a flexible connection element such as a polymeric filament extends from a manually lifted knob to a connection point on the latch arm, which can be a vertically displaceable pin. The arrangement is such that the flexible element is extended and perhaps tensioned when the latch arm is in the latching position. The arrangement is such that after movement of the door to an open position the biasing means retains the latch arm in its retracted position and tension previously applied to the flexible element is relieved so that no or only negligible load is applied against the biasing means.

### BRIEF DESCRIPTION OF THE DRAWINGS

The invention will be further described with reference to an illustrated embodiment and the accompanying drawings of which:

FIG. 1 is a schematic perspective view showing interior structure of a first embodiment incorporating a linkage providing lost motion at upper and lower connectors;

FIG. 2 is an axial cross-sectional view of the embodiment of FIG. 1 but when inter-engaged with a magnetic latch;

FIG. 3 is a schematic perspective view of a second embodiment using a flexible connector to provide a lost motion arrangement; and

FIG. 4 is an axial cross-sectional view corresponding to FIG. 3 showing the extended position of a latch pin for latching purposes.

### DETAILED DESCRIPTION OF THE DRAWINGS

The embodiments illustrated are intended to be used for latching gates, doors or the like and utilises a magnetic latching function. This arrangement is especially useful where the application is to a self closing door and no resistance is experienced as the door reaches its closed position as a conventional striker latch and striker plate is not used. Instead magnetic latching is provided as described below.

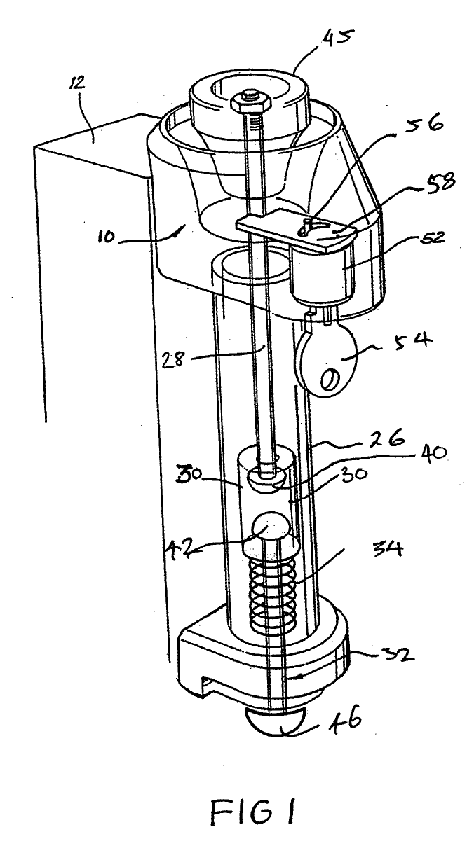

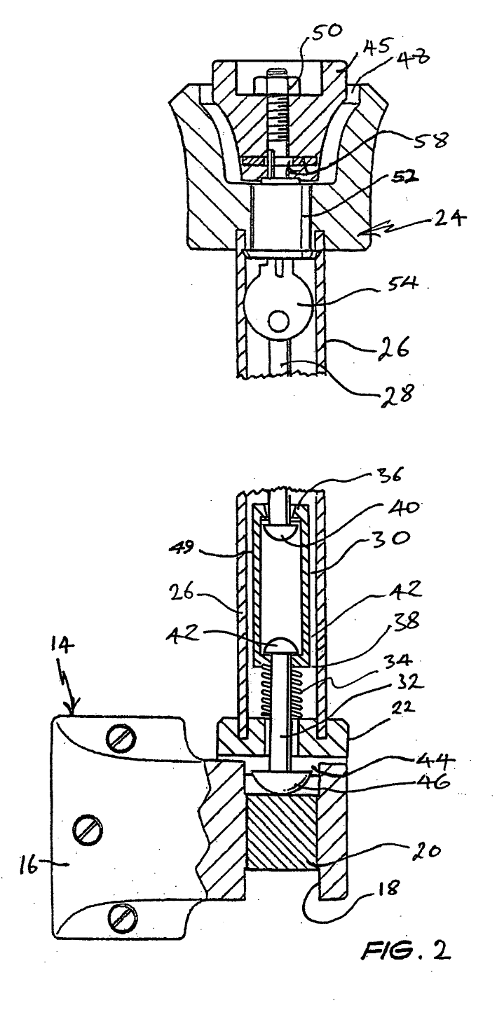

Referring first to FIGS. 1 and 2, a magnetic latch is provided and adapted to be mounted on a post 12 forming the frame of a gate and latch block 14 shown in FIG. 2 is provided and adapted to be mounted to the gate post 12 (as shown in FIG. 1). The latch block 14 has a main body 16 having a tubular boar 18 into which a high strength cylindrical magnet 20 is inserted and secured in a whether proof and sealed environment.

The main latch 10 has a lower mount 22 adapted to be attached by screws to the gate post 12 and an upper housing 24 also adapted to be mounted to the gate post 12 and between which a tubular housing 26 extends. The tubular housing 26 enshrouds a rigid actuating link 28, a connecting link 30 and a lower magnetic pin 32. A helical return spring 34 surrounds the pin 32 and urges the link 30 upwardly. The link 30 in this embodiment is generally tubular with end walls 36 and 38 having respective passages through which the link 28 and pin 32 extend to be terminated in respective enlarged heads 40 and 42. FIG. 2 shows the latching position where the latch pin 32 has been pulled down by the magnet 20 to engage in a latching cavity 44, the domed latching head 46 being a clearance fit in the cavity. When the spring 34 is compressed, the link 30 falls downwardly and there is little or no clearance between the confronting surfaces of the heads 40 and 42 and their respective end wall faces 36 and 38.

The upper housing 24 mounts a vertically displaceable pull knob 46 which is fixed to the upper end of the rigid link 28 by a nut 50. To open the gate from the latching position shown in FIG. 2, the knob 46 is pulled upwardly thereby pulling up the link 30 and the pin 32 against the magnetic force so that the door or gate can be swung open to reach the position shown in FIG. 1. At this location the spring 34 has extended to maintain the link 30 pushed upwardly and then freedom of motion is available between at least the head 40 on the fixed link 28 but there is also freedom of motion at the pin 32.

This embodiment also includes a cylinder lock 52 actuated by a key 54 and which can operate, through pin 56, a laterally displaceable locking plate 58. When the knob 46 has been released, the latching plate can be displaced by the key to lock the knob downwardly. This can be affected in any position including configuration shown in FIG. 1 and also in FIG. 2. Thus if a self closer arrangement is provided for the gate and locking is affected, release of the gate causes magnetic latching and the freedom of motion arrangement causes secure and safe latching. This can be most important in security applications such as swimming pool gates designed to inhibit the unauthorised entry of young children.

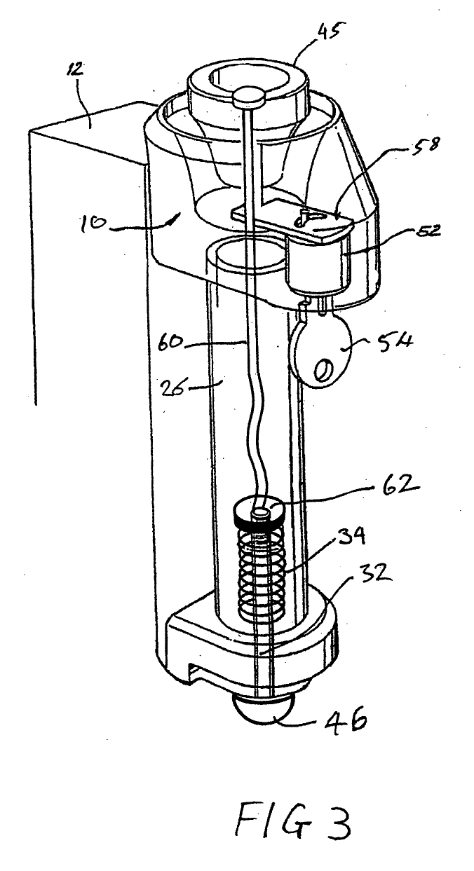

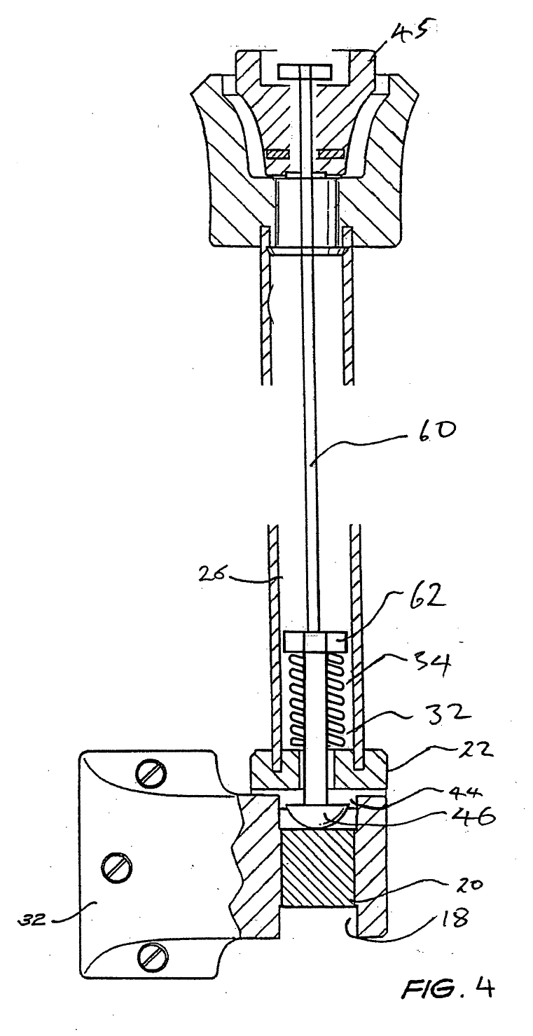

Referring now to FIGS. 3 and 4 an alternative embodiment is described and only the differences will now be highlighted. In this embodiment a flexible line 60 is provided to interconnect with the knob 46 and connects to an upper disc 62 connected to the magnetic latching pin 32.

In the latching position shown in FIG. 4 the flexible connection line 60 is extended and may be under tension. This is especially beneficial if a degree of elasticity is provided for in the material chosen. On lifting the knob 46 the pin 32 is lifted thereby permitting the latching head 46 to be clear of the recess, the recess having a shoulder suitably aligned with the exit direction. When the knob 46 is released with the gate in an open position the knob falls down thereby allowing the flexible element 60 to no longer be tensioned and it, at its lower end, while substantially supported by the knob, buckles so there is minimal weight on the pin 32 which can then be readily supported by a relatively light grade helical spring 34.

1. A self-latching device for latching, in a predetermined position, two members which are otherwise moveable relative to one another, the device comprising:
(i) a latch arm; and
(ii) a retaining element which in use provides a latching shoulder for the latch arm to prevent relative movement of the members;
(iii) at least one of the latch arm and the retaining element providing a strong magnetic field and the other having magnetic properties;
(iv) the latch arm being arranged to be displaceably mounted on a first of said members and the retaining element being arranged to be associated with the second of said members, the latch arm and the retaining element undergo relative movement into a latching position, when the members are in the predetermined position, under the influence of the magnetic field substantially to prevent relative movement of the two members by engagement portion of the latch arm and latching shoulder interengaging, and the latch arm being displaceable under applied force away from the retaining element to a retracted position so that the members may be moved apart;
the device further comprises:
(v) a biasing means arranged to bias the latch arm towards the retracted position, the biasing means being arranged to impart a force on the latch arm which is less than the biasing force imparted on the latch arm by the magnetic field when the members are located in the predetermined position;
(vi) actuating means arranged to be mounted on the first of the members in association with the latch arm to respond to an actuating input to displace the latch arm from its latching position to its retracted position, whereby the two members may be moved apart away from the predetermined position and, on removal of the actuation input, the actuating means is free to return to its initial position and the biasing means maintains the latch arm substantially in its retracted position, and when the members return to the predetermined position, the latch arm then being displaceable under the magnetic forces against the biasing means to re-establish its latching position; and
(vii) the actuating means substantially avoiding load being applied to the latch arm in all its positions by either:
(a) a multi-link structure having a degree of lost motion at each link, or
(b) a flexible element which is tensioned to absorb slack when the latch arm is displaced to its retracted position and when displacement actuator input is removed the flexible element buckles.

2. A device as claimed in claim 1, wherein the latch arm is mounted for vertical reciprocation in a housing and the housing also mounts the actuator which as in the form of a manually gripped element.

3. A device as claimed in claim 2, and further comprising a cylinder lock for locking the actuating means.

4. A device as claimed in claim 1, wherein high strength magnet material is sealed in a body of the retaining element and the latch arm has a steel pin of magnetic characteristics.

5. A device as claimed in claim 1, wherein the actuating means is adapted to be remotely power operated.

6. A self-latching device for latching, in a predetermined position, two members which are otherwise moveable relative to one another, the device comprising:
(i) a latch arm mounted in a housing for vertical reciprocating motion; and
(ii) a retaining element which in use provides a latching shoulder for the latch arm to prevent relative movement of the members;
(iii) at least one of the latch arm and the retaining element providing a strong magnetic field and the other having magnetic properties;
(iv) the latch arm being arranged to be displaceably mounted on a first of said members and the retaining element being arranged to be associated with the second of said members, the latch arm and the retaining element undergo relative movement into a latching position, when the members are in the predetermined position, under the influence of the magnetic field substantially to prevent relative movement of the two members by engagement portion of the latch arm and latching shoulder interengaging, and the latch arm being displaceable under applied force away from the retaining element to a retracted position so that the members may be moved apart;
the device further comprises:
(v) a biasing means arranged to bias the latch arm towards the retracted position, the biasing means being arranged to impart a force on the latch arm which is less than the biasing force imparted on the latch arm by the magnetic field when the members are located in the predetermined position;
(vi) actuating means in the form of a manually gripped actuator element mounted on the housing of the latch arm to respond to an actuating input to displace the latch arm from its latching position to its retracted position, whereby the two members may then be moved apart away from the predetermined position and, on removal of the actuation input, the actuating means is free to return to its initial position and the biasing means maintains the latch arm substantially in its retracted position, and when the members return to the predetermined position the latch arm is then displaceable under the magnetic forces against the biasing means to re-establish its latching position;
(vii) the actuating means substantially avoiding load being applied to the latch arm in all its positions by a flexible element which provides a lost motion effect and is tensioned to absorb slack when the actuator element commences upward motion from the latching position in which it normally is buckled.

7. A device as claimed in claim 6, further comprising a cylinder lock for locking the actuating means, and associated with an upper support in the housing for supporting the actuator element when released.

8. A device as claimed in claim 6, wherein high strength magnet material is sealed in a body of the retaining element and the latch arm has a steel pin of magnetic characteristics.

9. A device as claimed in claim 6, wherein the actuating means is adapted to be remotely power operated.

10. A self-latching device for latching, in a predetermined position, two members which are otherwise moveable relative to one another, the device comprising:
(i) a latch arm mounted in a housing for vertical reciprocity motion; and
(ii) a retaining element which in use provides a latching shoulder for the latch arm to prevent relative movement of the members;
(iii) at least one of the latch arm and the retaining element providing a strong magnetic field and the other having magnetic properties;
(iv) the latch arm being arranged to be displaceably mounted on a first of said members and the retaining element being arranged to be associated with the second of said members, the latch arm and the retaining element undergo relative movement into a latching position, when the members are in the predetermined position, under the influence of the magnetic field substantially to prevent relative movement of the two members by engagement portion of the latch arm and latching shoulder interengaging, and the latch arm being displaceable under applied force away from the retaining element to a retracted position so that the members may be moved apart;
the device further comprises:
(v) a biasing means arranged to bias the latch arm towards the retracted position, the biasing means being arranged to impart a force on the latch arm which is less than the biasing force imparted on the latch arm by the magnetic field when the members are located in the predetermined position;
(vi) actuating means in the form of a manually gripped actuator element mounted on the housing of the latch arm to respond to an actuating input to displace the latch arm from its latching position to its retracted position, whereby the two members may then be moved apart away from the predetermined position and, on removal of the actuation input, the actuating means is free to return to its initial position and the biasing means maintains the latch arm substantially in its retracted position, and when the members return to the predetermined position the latch arm is then displaceable under the magnetic forces against the biasing means to re-establish its latching position;
(vii) and a multi-link structure in the actuating means providing a lost motion effect whereby on the latch arm is substantially avoided and the actuator means, when released, is supported by the housing.

11. A device as claimed in claim 10, further comprising a cylinder lock for locking the actuating means, and associated with an upper support in the housing for supporting the actuator element when released.

12. A device as claimed in claim 10, wherein high strength magnet material is sealed in a body of the retaining element and the latch arm has a steel pin of magnetic characteristics.

13. A device as claimed in claim 10, wherein the actuating means is adapted to be remotely power operated.
